(19) United States
(12) Patent Application Publication
(10) Pub. No.: US 2025/0236777 A1
(43) Pub. Date: Jul. 24, 2025

(54) WATER-BASED DRILLING MUD FORMULATION USING WASTEWATER DISCHARGE

(71) Applicant: Saudi Arabian Oil Company, Dhahran (SA)

(72) Inventors: Jothibasu Ramasamy, Dhahran (SA); Subhash C. Ayirala, Dhahran (SA); Mohammed K. Arfaj, Dammam (SA); Salah Hamad Al-Saleh, Dhahran (SA)

(73) Assignee: Saudi Arabian Oil Company, Dhahran (SA)

(21) Appl. No.: 19/175,248

(22) Filed: Apr. 10, 2025

Related U.S. Application Data
(63) Continuation of application No. 18/056,556, filed on Nov. 17, 2022.

(51) Int. Cl. C09K 8/05; C09K 8/08; C09K 8/20

(52) U.S. Cl. CPC C09K 8/05; C09K 8/08; C09K 8/206; C09K 2208/18

(57) ABSTRACT

Described is a wastewater-based drilling fluid. The wastewater-based drilling fluid consists of about 40% to 60% by volume of a high salinity wastewater discharge. The wastewater-based drilling fluid also includes calcium carbonate as a bridging agent and barite as a weighting agent. The wastewater-based drilling fluid possesses a set of rheological properties and filtration control properties characteristic of a water-based drilling fluid.

### BACKGROUND

Oil and gas operations involve the circulation of drilling fluid throughout the drilling operation. Drilling fluid, also referred to as drilling mud, may include a water, oil, or synthetic base fluid. The choice for using a specific type of base fluid depends on the field conditions and operation requirements at a particular drilling site.

Water-based drilling mud is often a preferred choice, as the preparation cost is low compared to oil-based and synthetic-based mud systems. Moreover, water-based drilling mud is preferred because of its environmentally benign nature. Groundwater is often the source for a water-based mud formulation. In contrast, the use of recycled high salinity wastewater for a water-based mud formulation is not common for various reasons, including compatibility issues with chemical additives, corrosion of downhole equipment, issues during cementing due to impurity, and formation damage issues.

Zero Liquid Discharge (ZLD) is a treatment process for removing liquid waste from a system. The purpose of ZLD is to reduce wastewater economically and produce clean water that is suitable for reuse. Disposal of waste discharge from ZLD-produced water desalination plants remains an issue due to environmental concerns if the water may be discharged on land or water bodies. A produced water desalination plant employs a pre-treatment system to lower residual oil and dissolved H₂S content to less than 10 parts per million (ppm) in produced water. The pre-treated produced water is then processed using an evaporation based “dynamic vapor recovery” technology to desalinate the produced water.

The discharge obtained from ZLD-produced water desalination may be used for different upstream applications, such as injection water for reservoir re-injection in water flooding, makeup water for improved oil recovery and/or enhanced oil recovery (IOR/EOR) processes, desired low salinity water for fracking operations, wash water for crude oil desalting, and irrigation.

The water recovery efficiency in a typical ZLD produced water desalination system is approximately 80-90%; however, the system generates up to 10-20% volume of concentrated brine enriched with salts as the waste discharge. The discharge of these concentrated waste brines back into the sea can affect the organisms in the discharge area. Discharge on land leaves salt residue deposition after evaporation. Due to the high saline concentration of the discharge water, there are currently limited options for recycling of the discharge water.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a wastewater-based drilling fluid comprising a high salinity wastewater discharge occupying from about 40% to about 60% by volume of the wastewater-based drilling fluid, calcium carbonate as a bridging agent, and barite as a weighting agent. The wastewater-based drilling fluid possesses a set of rheological properties and filtration control properties characteristic of a water-based drilling fluid.

In another aspect, the high salinity wastewater discharge comprises 100,000 parts per million (ppm) to 200,000 ppm of sodium and 100,000 ppm to 200,000 ppm of chloride.

In another aspect, the high salinity wastewater discharge comprises 1,000 ppm to 3,000 ppm of sulfate, 1,000 ppm to 2,000 ppm of bicarbonate, 3,000 ppm to 6,000 ppm of potassium, 25,000 ppm to 50,000 ppm of calcium, and 3,000 ppm to 6,000 ppm of magnesium.

In another aspect, calcium carbonate is present in an amount ranging from 12% (w/v) to 16% (w/v).

In another aspect, barite is present in an amount ranging from 15% (w/v) to 25% (w/v).

In yet another aspect, the wastewater-based drilling fluid comprises bentonite in an amount ranging from 2% (w/v) to 4% (w/v).

In another aspect, the high salinity wastewater discharge is a zero liquid discharge (ZLD) wastewater discharge.

Other aspects and advantages of the claimed subject matter will be apparent from the following description and the appended claims.

### BRIEF DESCRIPTION OF DRAWINGS

FIG. 1 illustrates an ion profile of wastewater discharge from a Zero Liquid Discharge (ZLD)-produced water desalination plant according to some embodiments of the present disclosure.

FIGS. 2-5 illustrate rheological and filtration control properties of drilling fluid formulations produced according to some embodiments of the present disclosure.

### DETAILED DESCRIPTION

In one aspect, embodiments disclosed herein relate to the use of high salinity wastewater discharge from Zero Liquid Discharge (ZLD)-produced water desalination plants for drilling fluid applications. Conventionally, tap water or fresh groundwater are used to produce drilling fluid formulations. The formulation according to embodiments of this disclosure uses salt ridden wastewater discharged from ZLD desalination plants as a base fluid to formulate water mud formulation. A ZLD desalination plant, or ZLD produced water management system, uses dynamic vapor recovery technology to generate desired quality low salinity water from produced water for different upstream application. A waste stream is generated following removal of salt from the produced water. The wastewater from the waste stream may be collected and used to formulate the water-based mud described herein. The formulation described herein enables the recycling of ZLD wastewater discharge to avoid disposal concerns for the environment. Additionally, significant volumes of fresh groundwater may be saved with the recycling of the wastewater discharge.

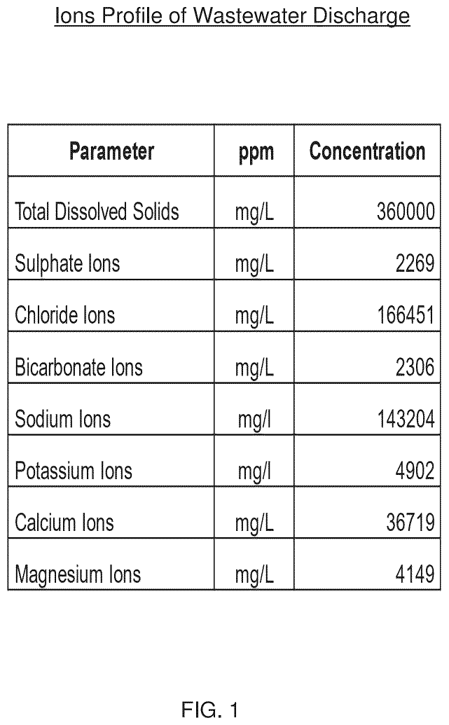

Conventional additives in water-based mud were evaluated for use in wastewater-based mud. Specifically, conventional additives were screened in tap water alone as well as a tap water and ZLD wastewater discharge mixture. The two solutions were compared in order to achieve properties suitable for drilling fluid applications. Experiments were conducted that exemplify the invention. The results are presented in FIGS. 1-5 and described below. The table in FIG. 1 shows the ion profile of wastewater discharge from a ZLD-produced water desalination plant. Total dissolved solids (TDS) was 360,000 parts per million (ppm) and contained both monovalent and divalent ions. As shown in FIG. 1, sodium and chloride were the major constituents in the ZLD wastewater discharge at approximately 100,000 ppm to 200,000 ppm of sodium, such as 143,204 ppm of sodium, and 100,000 ppm to 200,000 ppm of chloride, such as 166,451 ppm of chloride. Additionally, the high salinity wastewater discharge comprises 1,000 ppm to 3,000 ppm of sulfate, such as 2269 ppm of sulfate; 1,000 ppm to 3,000 ppm of bicarbonate, such as 2,306 ppm of bicarbonate; 3,000 ppm to 6,000 ppm of potassium, such as 4,902 ppm of potassium; 25,000 ppm to 50,000 ppm of calcium, such as 36,719 ppm of calcium; and 3,000 ppm to 6,000 ppm of magnesium, such as 4,149 ppm of magnesium.

To achieve a drilling fluid formulation useful for drilling fluid applications, the rheological properties and filtration control properties of the wastewater-based drilling fluid formulation need to be similar to those in conventional water-based drilling fluid formulations. Typically, drilling mud rheology is measured continuously during drilling at the rig site. The drilling mud rheology is adjusted with additives and/or dilution to meet drilling operation requirements. The rheology of a fluid may be characterized in terms of plastic viscosity (PV) and yield point (YP) parameters. The YP and PV are parameters from the Bingham plastic (BP) rheology model. PV is the resistance to flow caused by mechanical friction. The PV represents the viscosity of a fluid when extrapolated to infinite shear rate and is expressed in units of centipoise (cP). The PV indicates the type and concentration of the solids in the fluid. The PV parameter is affected by the concentration of solids in the drilling fluid, sizes and shapes of solids, and viscosity of the fluid phase. A low PV is desired.

The YP parameter is determined by extrapolating the BP model to a shear rate of zero, which represents the stress required to move the fluid. The YP is expressed in units of pounds per 100 square feet (lb/100 ft²). The YP is used as an indicator of the ability of drilling fluids to suspend solids and remove them from the wellbore, also known as carrying capacity or hole cleaning ability.

For the purposes of this disclosure, both PV and YP were calculated using 300 revolutions per minute (rpm) and 600 rpm shear rate readings on a standard oilfield viscometer as follows:

$$PV = ( 600 rpm reading ) - 300 rpm reading ) \qquad ( 1 )$$

$$YP = ( 300 rpm reading ) - PV . \qquad ( 2 )$$

Additionally, the filtration control properties of a drilling fluid are significant to its effectiveness, particularly when drilling through permeable formations in which the hydrostatic pressure exceeds the formation pressure. A drilling fluid needs to quickly form a filter cake, which effectively minimizes fluid loss. In addition, the drilling fluid must be thin and erodible enough to allow product to flow into the wellbore during production. Filtration control materials, such as starch-based biopolymers, reduce the amount of fluid that will be lost from the drilling fluid into a subsurface formation.

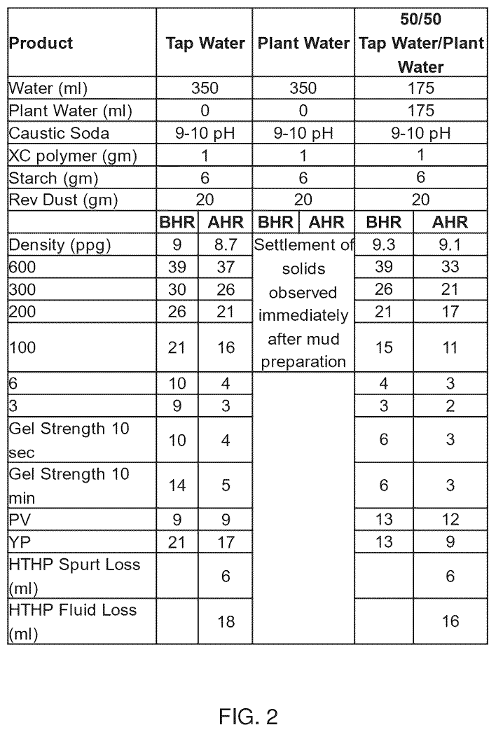

Some chemical additives typically used in water-based mud may be incompatible with ZLD wastewater discharge due to its high salinity. The table in FIG. 2 shows drilling fluid formulations produced for an initial screening of additives. A first drilling fluid formulation (200) was produced from tap water alone. A second drilling fluid formulation (202) was produced from ZLD wastewater discharge alone. The prepared drilling fluids were aged by hot rolling (HR) under 500 pounds per square inch (psi) at 212° F. for 16 hours (h). Optimal drilling fluid properties were achieved with the tap water formulation. Settlement of solids, such as solid additives (e.g., Rev Dust), were immediately observed in the formulation made using ZLD wastewater discharge alone, preventing its use. Therefore, a third drilling fluid formulation (204) comprised of 50% tap water and 50% ZLD wastewater discharge by volume was prepared. As can be appreciated by one skilled in the art, other fractions of tap water and ZLD water close to 50% are possible. For example, the high salinity wastewater discharge occupies from about 40% to about 60% by volume of the final drilling fluid formulation.

Each of the formulations was produced with amounts of caustic soda (sodium hydroxide (NaOH)), XC polymer (Xanthan gum biopolymer), a starch, and Rev Dust as initial additives, as listed in FIG. 2. The amounts listed are not intended to limit the composition of the drilling fluid formulation. XC polymer may be present in a produced wastewater-based drilling fluid in an amount ranging from 0.1 grams to 10 grams, such as 0.5 grams to 2 grams. A starch additive may be present in an amount ranging from 0.1 grams to 20 grams, such as four grams to eight grams. Rev Dust may be present in the produced drilling fluid in an amount ranging from 0 grams to 20 grams, such as 15 grams to 20 grams.

Properties analyzed included density (a filtration control property), gel strength, PV, YP, high temperature high pressure (HTHP) spurt loss, and HTHP fluid loss. HTHP spurt loss is the amount of fluid lost in the first part of the experiments, such as the first 30 seconds of the experiment. Spurt loss is the instantaneous volume of liquid that passes through a filter medium prior to deposition of a filter cake. HTHP fluid loss is the amount of fluid lost during the entire experiment time, such as 30 minutes. Each of these properties was analyzed before (BHR) and after (AHR) hot rolling to assess characteristics of the additives before and after exposure to high temperature and high pressure. Gel strength of a drilling fluid is defined as the shear stress measured at a low shear rate after a mud has set for a period of time, typically ten seconds and ten minutes.

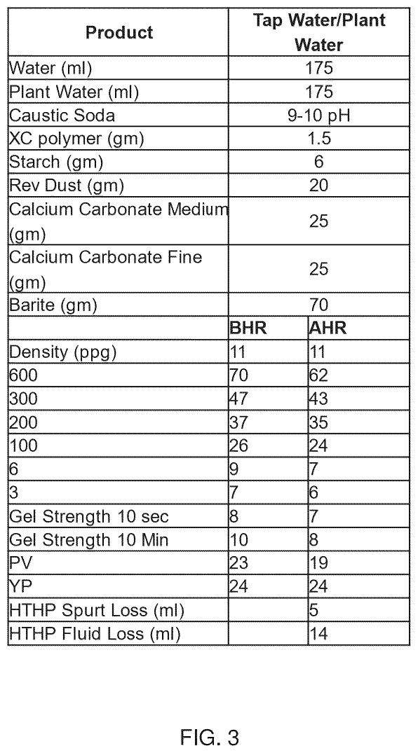

Additional additives were evaluated for compatibility in additional experiments. Specifically, amounts of calcium carbonate fine, calcium carbonate medium, and barite were added to the formulation. The table in FIG. 3 lists non-limiting values for the additives and characteristics of the tap water and ZLD wastewater discharge mixture formulated with the additives. With respect to a drilling fluid formulation, calcium carbonate is used as a bridging agent to plug fractures, and barite is used as a weighting agent to provide required density to the fluid. Calcium carbonate fine may be present in a produced wastewater-based drilling fluid in an amount ranging from 0.1 grams to 100 grams, such as 20 grams to 30 grams. Calcium carbonate medium may be present in an amount ranging from 0.1 grams to ppm grams, such as 20 grams to 30 grams. Total calcium carbonate may be present in an amount ranging from 12% (w/v) to 16% (w/v) of the drilling fluid formulation. Barite may be present in an amount ranging from 0.1 grams to 350 grams, such as 50 grams to 100 grams, which equates to 15% (w/v) to 25% (w/v) of the drilling fluid formulation.

Parameters analyzed included density, gel strength, PV, YP, HTHP spurt loss, and HTHP fluid loss. Each of these parameters was analyzed before (BHR) and after (AHR) hot rolling. The rheological properties analyzed were all within ranges considered acceptable for an effective drilling fluid formulation. The filtration control property for the formulation with the additional additives was determined to be acceptable even for the formulation that was hot rolled for 16 h at 500 psi and 212° F., as indicated by the YP, gel strength, and HPHT fluid loss values. YP is the primary indicator of the rheological property of the drilling mud formulation. The recommended YP depends on several factors, such as formation type, mud type, and hole section. A YP value in the range of 10 to 40 is considered acceptable. Ideally, the filtration control properties, HTHP spurt loss and HTHP fluid loss, are as low as possible. A range of 5 ml to 25 ml of filtration loss is considered acceptable.

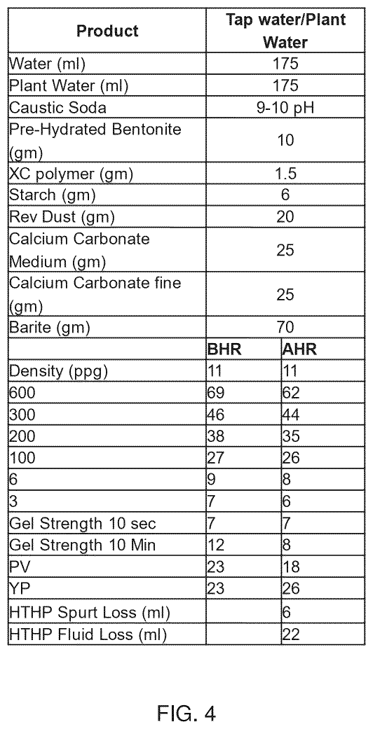

Bentonite is a common additive used in drilling fluid to provide viscosity along with XC polymer. Hence, determining properties of bentonite that make it compatible with ZLD wastewater discharge is significant in producing a robust drilling fluid formulation. The table in FIG. 4 lists characteristics of the tap water and ZLD wastewater discharge mixture formulated with the addition of bentonite. Bentonite may be present in the produced drilling fluid formulation in an amount ranging from 0.1 grams to 50 grams, such as 5 grams to 15 grams, which equates to 2% (w/v) to 4% (w/v) of the drilling fluid formulation.

As shown in FIG. 4, excellent rheological properties were obtained for hot rolled mud. While the fluid loss control property value (HTHP fluid loss) increased compared to the formulations without bentonite, the value was still within the acceptable range of 0 ml to 25 ml of fluid loss.

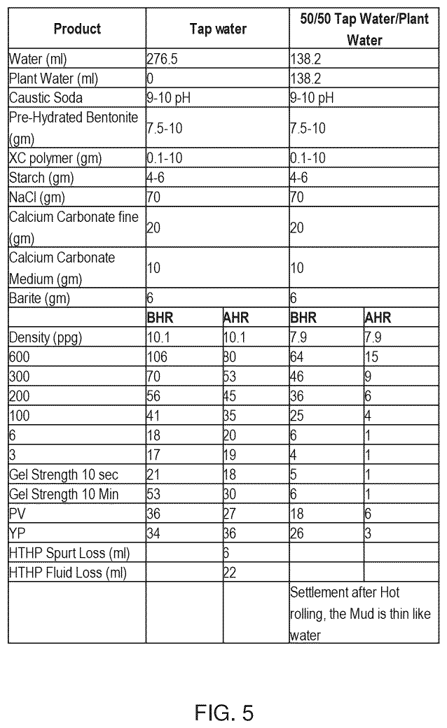

Furthermore, a formulation with the addition of sodium chloride (NaCl), was analyzed. As the ZLD wastewater discharge was known to be saturated with salts, it was expected that the addition of NaCl would deteriorate the properties of the mud formulation. As shown in the table of FIG. 5, both rheological and fluid loss properties were compromised with the addition of NaCl, as indicated by the decreases in values of the properties in the 50/50 tap water/plant water. Additionally, settlement was observed after hot rolling, and the drilling fluid formulation was thin.

The drilling fluid formulation using 50% tap water, 50% ZLD wastewater discharge, and the additives presented in FIG. 4 was determined to be ideal for the purpose of drilling fluid applications. The formulation was determined to possess a set of rheological and filtration control properties characteristic of water-based drilling fluid formulations. Through experimental studies, it was determined that most conventional drilling fluid additives work well in the ZLD wastewater discharge formulation, although additives known to be sensitive to salt were screened out. The properties achieved for ZLD wastewater discharge mud formulation are comparable with the properties achieved using regular water-based mud.

The drilling fluid formulation described herein uses high salt concentrated waste reject streams obtained from ZLD wastewater discharge to formulate water-based mud formulations for drilling applications. Such applicability of wastewater streams for potential reuse in drilling applications avoids the waste disposal to the environment and contributes to environmental sustainability.

Unless defined otherwise, all technical and scientific terms used have the same meaning as commonly understood by one of ordinary skill in the art to which these systems, apparatuses, methods, processes, and compositions belong.

The singular forms “a,” “an,” and “the” include plural referents, unless the context clearly dictates otherwise.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

When the word “approximately” or “about” are used, this term may mean that there can be a variance in value of up to ±10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

1. (canceled)

2. (canceled)

3. (canceled)

4. (canceled)

5. (canceled)

6. (canceled)

7. (canceled)

8. A method for forming a drilling fluid, comprising:
obtaining a high salinity wastewater discharge from zero liquid discharge (ZLD) produced water;
adding one or more chemical additives to the high salinity wastewater discharge to produce a wastewater-based drilling fluid; and
using the wastewater-based drilling fluid for drilling fluid applications.

9. The method of claim 8, comprising determining the one or more chemical additives that produce a desired set of rheological properties in the wastewater-based drilling fluid.

10. The method of claim 9, wherein the desired set of rheological properties are similar to a set of rheological properties of a water-based drilling fluid, as characterized by a plastic viscosity parameter and a yield point parameter.

11. The method of claim 8, wherein the wastewater-based drilling fluid comprises 40% to 60% by volume of the high salinity wastewater discharge.

12. The method of claim 8, wherein obtaining the high salinity wastewater discharge from ZLD produced water comprises:
treating produced water to lower dissolved H₂S to less than 10 parts per million (ppm), generating a pre-treated produced water; and
desalinating the pre-treated produced water to obtain a low salinity water and the high salinity wastewater discharge.

13. The method of claim 8, wherein the high salinity wastewater discharge comprises 100,000 parts per million (ppm) to 200,000 ppm of sodium and 100,000 ppm to 200,000 ppm of chloride.

14. The method of claim 8, wherein the high salinity wastewater discharge comprises 1,000 parts per million (ppm) to 3,000 ppm of sulfate, 1,000 ppm to 3,000 ppm of bicarbonate, 3,000 ppm to 6,000 ppm of potassium, 25,000 ppm to 50,000 ppm of calcium, and 3,000 ppm to 6,000 ppm of magnesium.

15. The method of claim 8, wherein the wastewater-based drilling fluid comprises calcium carbonate in an amount ranging from 12% (w/v) to 16% (w/v).

16. The method of claim 8, wherein the wastewater-based drilling fluid comprises barite in an amount ranging from 15% (w/v) to 25% (w/v).

17. The method of claim 8, wherein the wastewater-based drilling fluid comprises bentonite in an amount ranging from 2% (w/v) to 4% (w/v).
